(19) United States
(12) Patent Application Publication
(10) Pub. No.: US 2021/0086639 A1
(43) Pub. Date: Mar. 25, 2021

(54) System and Method for Automated Conductive Charging of an Electric Vehicle

(71) Applicant: ABB Schweiz AG, Baden (CH)

(72) Inventors: Stefan Rakuff, Windsor, CT (US); Martin Krucinski, Glastonbury, CT (US); Gregory A. Cole, West Hartford, CT (US); Thomas A. Fuhlbrigge, Ellington, CT (US)

(73) Assignee: ABB Schweiz AG, Baden (CH)

(21) Appl. No.: 16/579,592

(22) Filed: Sep. 23, 2019

(51) Int. Cl. B60L 53/35; B60L 53/31; B60L 53/18; B60L 53/16

(52) U.S. Cl. CPC B60L 53/35; B60L 53/16; B60L 53/18; B60L 53/31

(57) ABSTRACT

A charging station for automatically conductively charging an electric vehicle having an underbody receptacle cavity is provided. When charging, the charging station and the electric vehicle may spaced apart by a linear distance. Other alignment discrepancies may also exist between the electric vehicle and the charging station. To traverse the linear distance and align and insert the plug into the receptacle, the charging station may be capable of moving in multiple translational degrees of freedom.

### TECHNICAL FIELD

The present disclosure relates to charging systems and methods for electric vehicles and, more particularly, to systems and methods for automated positioning of electrical connectors between a charging station base and the vehicle.

### BACKGROUND

Use of electrical vehicles is becoming increasingly popular due to the environmental benefits of removing pollution caused by fossil fuel burning vehicle engines from the environment, especially in densely populated urban environments. As with most mobile electrical devices, electrical vehicles carry electrical power storage devices or batteries, which provide power to the vehicle propulsion and other systems. As can be appreciated, the vehicle batteries require periodic recharging to provide consistent vehicle operation.

At present, electric vehicle recharging is a time consuming process that is typically carried out over long periods, for example, overnight or during prolonged periods when the electric vehicle is parked. Power dispensers include flexible conduits or wire bundles that include a connector at their end, which plugs into a vehicle receptacle and then begins the transfer of power from the dispenser the vehicle's battery.

Traditional vehicle power dispensers operate at around 200-240 Volts AC, and transfer about 30 Amp of electrical power into a vehicle. As a consequence, providing a full charge to a vehicle can take up to 10 hours or more. With the increase in popularity of electric vehicles, convenient and user-friendly charging solutions requiring little to no manual intervention on the part of users are desirable

### SUMMARY OF THE DISCLOSURE

In an aspect, the disclosure describes an automatic conductive charging station for charging an electric vehicle. The charging station may be configured as an above-ground station and includes a station housing extending in a vertical direction from the ground surface to define a vertical axis. To align a plug with respect to the electric vehicle, the charging station can include an alignment mechanism disposed in the station housing. The alignment mechanism has an extension mechanism that can be extended and retracted with respect to the station housing in a linear direction normal to the vertical axis. The alignment mechanism also includes a lift jack that is disposed at the distal end of the extension mechanism and that can be actuated to raise and lower a jack platform with respect to the vertical axis.

In another aspect, the disclosure describes a method of conductively charging an electric vehicle. The method involves having a computer determine a linear distance and a spatial deviation between the charging station base and an electric vehicle having an underbody receptacle cavity. The distal end of an extension mechanism can be extended from the charging station in a linear direction toward and underneath the electric vehicle. The charging station can further actuate a lift jack at the distal end of the extension mechanism into the receptacle cavity.

In yet another aspect, the disclosure describes another example of an automatic conductive charging station for charging an electrical vehicle. The charging station includes a vertical station housing occupying spatial coordinates at a linear distance from a vehicle space for the electric vehicle. The charging station includes an alignment mechanism accommodated in the station housing that may have three translational degrees of freedom. The alignment mechanism may extend and retract an extension mechanism in a linear direction with respect to the vehicle space. Lastly, the alignment mechanism can elevate a lift jack at the distal end in a vertical direction with respect to the vehicle space to interact with a receptacle cavity on the electric vehicle.

Further and alternative aspects and features of the disclosed principles will be appreciated from the following detailed description and the accompanying drawings. As will be appreciated, the principles related to devices, systems, and methods for automated electrical connector positioning for EV charging disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a perspective and schematic view of an electric vehicle (EV) charging environment including an automatic charging device (ACD) in accordance with the disclosure.

FIG. 2 is a perspective view of an example of the charging station with the extension mechanism of the ACD as retracted into the station housing.

FIG. 3 is a perspective view of the example of a charging station with the extension mechanism of the ACD as extended from the station housing.

FIG. 4 is a perspective view of the extension drive and the rotatable platform of the ACD for extending, retracting, and rotating the extension mechanism.

FIG. 5 is a perspective view of an example of a lift jack of the ACD as vertically collapsed.

FIG. 6 is a perspective view of the example of the lift jack of FIG. 5 as vertically extended.

FIG. 7 is a perspective view of another example of a lift jack with an electric motor to vertically extend the lift jack.

FIG. 8 is an elevational view of the example of the lift jack of FIG. 7 with a detailed view of the leadscrew used to actuate the lift jack.

FIG. 9 is perspective view of another example of a lift jack for the ACD.

FIG. 10 is a side elevational view of the electric vehicle (EV) positioned before an automated charging device (ACD) during the automated charging process.

FIG. 11 is a top plan view of the electric vehicle (EV) and the automated charging device (ACD) during the automated charging process.

FIG. 12 is a flow diagram illustrating an example of a process the ACD may execute to recharge the electric vehicle (EV).

FIG. 13 is an elevational view of an example of the electrical connection between the electric vehicle and a plug attached to the extension mechanism.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

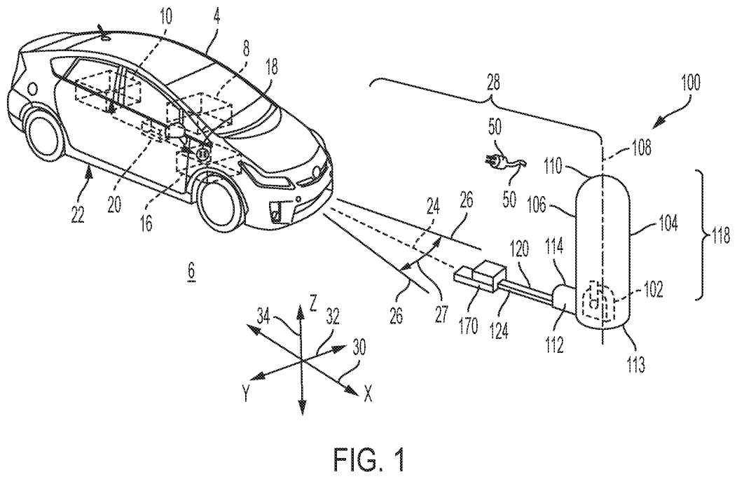

Now referring to FIG. 1, there is illustrated an example of an electric vehicle (“EV”) 4 on a surface 6 approaching an automated conductive charging station 100. In the illustrated example, the electric vehicle 4 is an automobile but may also be a truck, a utility vehicle, a motorcycle, or other mobile vehicle. The surface 6 may be the surface of a garage at a residence or business, or at a parking lot or any other location accessible by the electric vehicle 4. The electric vehicle 4 may be partially or completely electric powered by one or more electric motors 8 utilizing energy stored in rechargeable batteries 10 or electrical cells. The electric motor 8 can convert the electric energy stored in the batteries 10 to a motive force transmitted by a drivetrain for propelling the electric vehicle 4, and the batteries can provide electric energy for electrical systems associated with the electric vehicle. The electric vehicle 4 may be a hybrid vehicle and include an internal combustion engine in addition to the rechargeable batteries 10 for temporally providing power to the vehicle.

Operation of the electric vehicle 4 will deplete the rechargeable batteries 10 of the stored electrical energy such that the batteries must be periodically recharged by an external energy source. To electrically couple with the external energy source, the electric vehicle 4 includes a receptacle cavity 16 accommodating a socket or receptacle 18. The receptacle 18 can have any suitable structure for attachably and detachably interfacing with the external energy source and may accommodate prongs, pins, or other types of projections.

Additionally, the receptacle 18 may include planar, conductive mating surfaces that may conductively contact a corresponding mating surface associated with the external energy source to conductively transfer electricity there between. Accordingly, “receptacle” is used in the broadest context to mean any type of mateable structure for the transfer of electric energy. The external energy source may provide alternating current electricity whereas the rechargeable batteries 10 on the electric vehicle 4 may be adapted to store direct current electricity. To convert alternating current to storable direct current, the electric vehicle may include an AC-DC converter 20 in series with the receptacle 18 and the batteries 10.

The receptacle cavity 16 may be located on the underbody 22 of the electric vehicle 4 and oriented towards the ground surface 6 in what may be referred to as an underbody charging configuration. Because of its location on the underbody 22 of the electric vehicle 4, the receptacle cavity 16 may include a sliding door or panel that can enclose the cavity to protect the receptacle 18 from spray, dirt, salt and the like when the electric vehicle 4 is on the road, but that can slide open to provide access to the receptacle for charging. However, in other examples, the receptacle cavity 16 may be arranged at any accessible location on the electric vehicle 4. The electric vehicle 4 may include multiple receptacle cavities 16 and receptacles 18 for interacting with charging stations 100 of different infrastructural configurations. Aspects of the disclosure may be directed to conductive charging interaction between the electric vehicle 4 and the charging station 100 such that power transfer requires physical contact between electrically conductive structures on the vehicle and station respectively. However, aspects of the disclosure may be applicable to wireless power transfer or inductive charging infrastructures and exchanges.

Referring to FIG. 1, the electric vehicle 4, which may be controlled by a human driver or an autonomous driving system, may directly approach the charging station 100 with the front of the vehicle oriented in a centerline path 24 towards the charging station. In an embodiment, the charging station 100 may be an aboveground station or include components disposed above the ground surface 6 and which may project vertically from the ground. As illustrated, the electric vehicle 4 may stop and the drivetrain placed in park at a measurable spatial distance from the charging station 100; however, the electric vehicle 4 and the charging station 100 may be located at any relative orientation. For reference, the electric vehicle 4 and the charging station 100 may be spatially arranged with respect to an x-y-z coordinate system, wherein the linear direction 30 refers to the x-axis, the lateral direction 32 refers to the y-axis, and the vertical direction 34 refers to the z-axis. Particular aspects of the disclosure are directed to the illustrated example where the electric vehicle 4 and the charging station 100 are in a linearly spaced relation to each other at least with respect to the linear direction 30.

In accordance with such aspects, the electric vehicle 4 may stop a measurable linear distance 28 before or in front of the charging station 100. The illustrated linear distance 28 is for reference only and is not intended to represent any actual dimensions. The linear distance 28 may be aligned with the centerline path 24 of the electric vehicle 4 toward the charging station 100 and further may be aligned with the linear direction 30 defined by the x-y-z coordinate system. The linear distance 28 may be such that no portion of the electric vehicle 4 occupies the same coordinate positions of the charging station 100. This is desirable to avoid damage when, in the embodiment of an aboveground charging station 100, the height of the station may approach or be equal to the height of the electric vehicle 4. Note the linear distance 28 may be measurable between any point on the charging station 100 and any point on the electric vehicle 4, such as the front of the vehicle or in the receptacle cavity 16.

For various reasons, the final, relative orientation of the electrical vehicle 4 and the charging station 100 may deviate with respect to the centerline path 24 by a spatial deviation 26. The spatial deviation 26 may be with respect to the lateral direction 32 or y-axis, but may also include deviation in the vertical direction 34 or z-axis. The lateral arc of the spatial deviation 26 results in a deviation angle 27 that, in three dimensions, may form a conical area to include vertical components of the spatial deviation in the vertical direction 34 as well as the pitch, yaw and roll of the electric vehicle 4 as it approaches the charging station 100.

To conductively mate with the receptacle 18 in the receptacle cavity 16 of the electric vehicle 4, the charging station 100 can be associated with or accommodated with a plug 50 extending from an electrical conductor 52. The electrical conductor 52 may be a flexible cord carrying one or more conductive wires electrically coupled to an external power source. The plug 50 can have any structure and configuration to cooperatively connect with the receptacle 18 and may include pins, prongs, planar conductive surfaces, etc. It will be appreciated that when charging, the plug 50 and flexible conductor 52 need to traverse the linear distance 28 and address any spatial deviation 24 between the electric vehicle 4 and the charging station 100.

To address the spatial deviation 24 and the linear distance 28, the charging station 100 may include an alignment mechanism 102 accommodated in an enclosure or station housing 104. The alignment mechanism 102 is configured to move and align the plug 50 with respect to the electric vehicle to make an electrical connection with the receptacle cavity 16. In accordance with an aspect of the disclosure, the alignment mechanism 102 can be configured to translate in multiple translational degrees of freedom. These may include movements in the linear direction 30, the lateral direction 32, and the vertical direction 34. In addition to enabling movements with respect to the three translational degrees of freedom, the alignment mechanism 102 may also accommodate or be movable with respect to one or more rotational degrees of freedom by yawing, pitching, or rolling.

To accommodate the alignment mechanism 102, the station housing 104 may be a hollow enclosure having any suitable size or configuration. In the illustrations, the station housing may be post including a hollow, cylindrical structure 106 rising vertically with respect to the ground surface 6 to define a vertical axis 108 in the vertical direction 34 or Z-axis. To enclose the hollow cylindrical structure 106, the station housing 104 may include a domed lid 110. The station housing 104 may have any suitable diameter and may have any vertical height, for example, 6 to 18 inches in diameter by 3-5 feet in height. However, the station housing 104 may have other shapes and sizes such as an obelisk or the station housing 104 may be embodied in a planar wall. While the illustrated example depicts the station housing 104 vertically rising above the ground surface 6, in some examples, the station housing may also be partially or completely disposed below the surface 6 or underground. In other examples, the station housing may be a relatively short, squat structure protruding a few inches from the ground surface 6. The station housing 104 may be made from any suitable structural material such as plastic, metal, or cement. For reference purposes, the station housing 104 is depicted as transparent, but in other instances may be opaque.

To provide access for the enclosed alignment mechanism 102, the station housing 104 may include an access port 112 disposed into the lower portion of the cylindrical structure 106 generally located proximate the housing floor 113 proximate the ground surface 6. The access port 112 may be generally oriented in the linear direction 30 and may have any suitable shape or configuration. As illustrated, the access port 112 may include a canopy 114 extending radially outward from the cylindrical structure 106, although in other examples, the access port 112 may be only an aperture disposed into the cylindrical structure. Because the station housing 104 and certain components of the alignment mechanism 102 accommodated therein are stationary with respect to the ground surface 6, the combination of those components may be referred to as a charging station base 118.

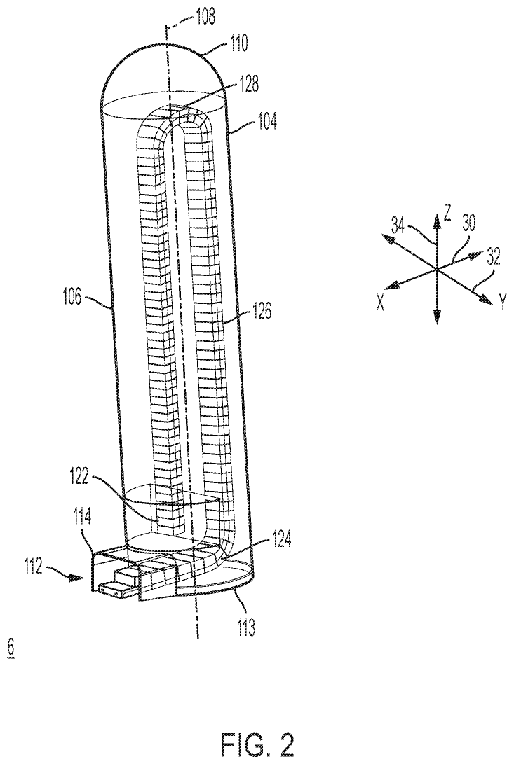

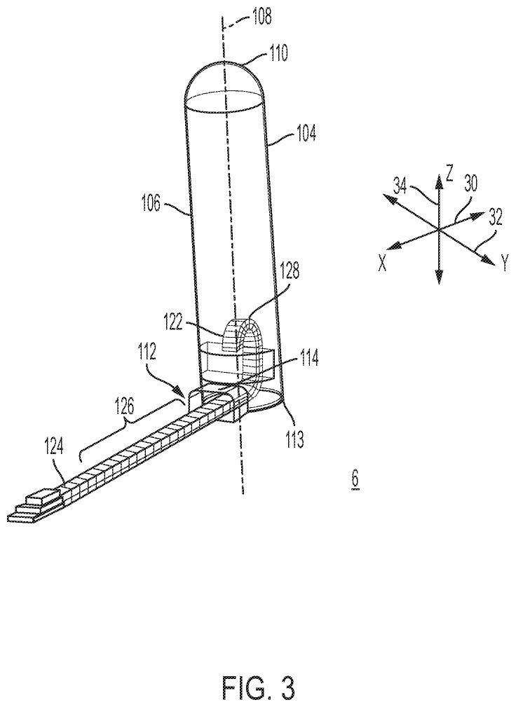

Referring to FIGS. 2 and 3, to traverse the linear distance between the station housing 104 and the electrical vehicle, the alignment mechanism 102 may include an extension mechanism 120 that can extend and retract from the station housing 104 through the access port 112. The extension mechanism 120 can be an elongated, flexible structure that is configured to fold upon itself when retracted into the station housing 104 and to unfold and linearly reposition itself horizontally adjacent to the ground surface 6 when extended. The extension mechanism 120 can extend between a proximal end 122 that may be fixed or secured inside the station housing 104 and a distal end 124 that is detached and free to move with respect to the station housing. The proximal end 122 can be attached to the inner surface of the cylindrical structure 106 generally above the access port 112 and the free distal end 124 can rest on the housing floor 113 of the station housing 104 adjacent the ground surface 6. To provide compliance and flexibility, a compliant track 126 can extend between and join the proximal end 122 and the distal end 124 and generally delineates the length of the extension mechanism 120. The length between the proximal and distal ends 122, 124 of the extension mechanism 120 may vary depending upon application, such as recharging of large trucks verses smaller passenger cars.

When the extension mechanism 120 is retracted or furled within the station housing 104, as illustrated in FIG. 2, the compliant track 126 is oriented in the vertical direction 34 extending from where the proximate end 122 attaches to the cylindrical structure 106 upwards toward the domed lid 110. The compliant property or characteristic of the compliant track 126 enables it to form a curve 128 about its length to extend downwardly toward the housing floor 113 of the station housing 104. When retracted, as illustrated in FIG. 2, the free distal end 124 of the extension mechanism 120 can be accommodated within the access port 112 of the station housing 104 proximate the housing floor 113. As illustrated in FIG. 3, when the extension mechanism 120 is extended, the distal end 124 linearly moves through the access port 112 followed by the trailing portion of the compliant track 126 that extends along the ground surface 6. The compliance or flexibility provided by the compliant track 126 enables the compliant track 126 to roll or undulate so that the curve 128 moves vertically with respect to the vertical direction 34 and the vertical axis 108 within the station housing 104 as the extension mechanism 120 moves through the access port 112. When extended, the extension mechanism 120 may be perpendicular to the vertical axis 108 of the station housing 104 and generally aligned with the linear direction 30 associated with the electric vehicle. In another example, the flexibility of the complaint track 126 may allow it to roll or coil in one or more circular loops having a generally continuous radius of curvature within the station housing. The loops may be disposed around a hub for support.

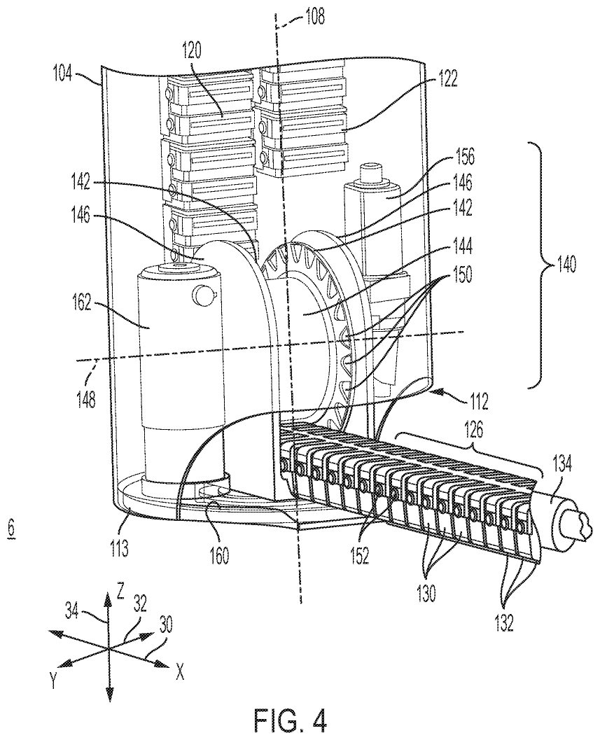

Referring to FIG. 4, to provide the flexible or compliant characteristic that enables the undulating motion and the ability of the compliant tract 126 to redirect itself, the complaint track 126 can be a chainlike structure assembled from a plurality of interconnected, pivoting links 130. The links 130 can be adjacently aligned along the length of the compliant track 126. The links 130 may be identical to each other and can have any suitable structure and shape to pivotally interlock with adjacent links 130 in the compliant track 126. For example, the links 130 may be rectangular, block-like structures with first and second, or forward and rearward peripheries 132 that are adapted and sized such that the peripheries of adjacent links 130 fit together. The peripheries 132 may include interlocking channels that enable adjacent links to moveably pivot with respect to each other. In other examples, adjacent links 130 may be pivotally interconnected by other mechanisms such as pins. A possible advantage of the chainlike structure may be that, when the pivotally connected links 130 are aligned longitudinally, the compliant track 126 may demonstrate rigidity in the lengthwise direction. However, if a portion of the compliant track 126 is redirected at a perpendicular or nonparallel angle from the longitudinal direction, the links 130 pivot with respect to each other enabling the track to curve and undulate and further enabling retraction of the extension mechanism 120 into the station housing 104 as described above.

In an embodiment, the rectangular links 130 may be hollow so that a flexible conductive cable 134 can extended through the aligned links 130 and be carried within the path of the compliant track 126. The conductive cable 134 can electrically connect with the flexible conductor associated with the plug. However, in other embodiments, the conductive cable 134 may be externally disposed with respect to the extension mechanism 120.

Referring to FIG. 4, to extend and retract the extension mechanism 120 from the station housing 104, the alignment mechanism 102 can include an extension-retraction drive 140 that is fixedly disposed on the housing floor 113. To physically engage the compliant track 126 of the extension mechanism 120, the extension-retraction drive 140 can include at least one rotatable sprocket that, in the illustrated example, can be structured as opposed, first and second sprocket plates 142. The sprocket plates 142 can be flat, circular plates that are in a spaced apart, opposing relation separated by a smaller diameter hub 144 that extends between the plates. The sprocket plates 142 and hub 144 may be rotatably supported above the housing floor 113 by a pair of opposing, bifurcated uprights 146 so that the circular sprocket plates 142 and hub 144 may rotate about a sprocket axis 148. When the extension-retraction drive 140 is fixedly mounted to the housing floor 113 of the station housing 104 by the bifurcated uprights 146, the sprocket axis 148 may be traverse to the axis port 112 disposed through the station housing 104. The bifurcated uprights 146 may further align and direct the extension mechanism 120 toward the access port 112.

Formed or profiled on inward facing surfaces of the sprocket plates 142, adjacent to the outer diameter of the plates, can be a plurality of arranged notches or teeth 150 that are directed radially outward with respect to the sprocket axis 148. The teeth 150 can be sized and shaped to receive and mesh with corresponding engagement cogs 152 that are formed on the sides of each of the rectangular shaped links 130 of the complaint track 126. To rotate the sprocket plates 142 and the teeth 150 thereon, an electric extension motor 156, such as a reversible direct current motor whose rotational direction change to enable extension or retraction of the extension mechanism. The extension motor may be stepper motor that can be rotated in precisely fixed steps, can be operatively coupled to the sprocket plates 142. The extension motor 156 may be vertically oriented and perpendicular to the sprocket axis 148 such that right angled gearing may be used to operatively couple the extension motor 156 and sprocket plates 142; but in other examples, the extension motor may have other orientations or configurations.

In operation, the compliant track 126 is directed vertically downward with respect to the vertical direction 34 and the vertical axis 108 to extend between the first and second sprocket plates 142. The compliant track 126 can partially wrap around the hub 144 so that the extension mechanism 120 aligns with and is generally directed toward the access port 112. The compliant track 142 may thereafter be oriented in the linear direction 30 or x-axis. Selective rotation of the sprocket plates 142 with respect to the sprocket axis 148 meshes the sprocket teeth 150 and cogs 152 to linearly drive the compliant track 126 of the extension mechanism 120 either outwardly through the access port 112 or inwardly into the station housing 104. It will be appreciated that the configuration of the extension motor 156 as a stepper motor allows relatively precise control over the linear extension and/or retraction of the extension mechanism 120. Thus, referring to FIGS. 1 and 4, selective activation of the extension-retraction drive 140 moves the distal end 124 of the extension mechanism 120 over the ground surface 6 in the linear direction 30 towards or away from the electric vehicle 4 and can precisely control the relative linear distances between the extension mechanism 120 and the electric vehicle 4.

To correct for misalignment or spatial deviation 26 that may occur in the lateral direction 34 between the charging station 100 and the electric vehicle 4, the alignment mechanism 102 accommodated in the station housing 104 can be configured to rotate with respect to the vertical axis 108. Referring to FIG. 4, to enable rotation, the housing floor 113 to which the extension-retraction drive 140 is mounted can be a rotatable platform 160 that may be supported on roller bearings or the like. The alignment mechanism 102 can include a platform motor 162 that may also be a reversible direct current motor and can rotatably engage the rotatable platform 160 through appropriate gearing to spin the housing floor 113 with respect to the vertical axis 108. Turning of the rotatable platform 160 results in sweeping angular movement of the compliant track 126 with respect to the vertical axis 108 and thus, with respect to FIG. 1, moves the distal end 124 of the extension mechanism 120 across the lateral direction 32 and thus can compensate for spatial deviation 26 in that direction. The charging station 100 can be configured so that the station housing 104 is mounted to and rotates with the rotatable platform 160 or can remain fixed to the ground surface 6 so that only the alignment mechanism 102 turns. In the later arrangement, the angular arc of the access port 112 may be sufficiently sized to allow angular movement of the elongated extension mechanism 120 over a foreseeable range of spatial deviation 26.

Other compliant or flexible structures are also contemplated for the compliant track 126. For example, an elongated band of reinforced rubber similar to a tire tread having compliant characteristics allowing it to fold and unfold may be utilized. The rubber band or tread may be further configured as a toothed belt having lateral teeth or cogs disposed thereon to enable the extension-retraction drive 140 to controllably extend and retract the extension mechanism similarly to the foregoing description. Other types of chain-like mechanisms, corrugated tubing, braided hoses, metal stranded tubing such as Helical Hollow Strand (HHS®) tubing available from Fort Wayne Metals, and the like may also be utilized for the compliant track 126.

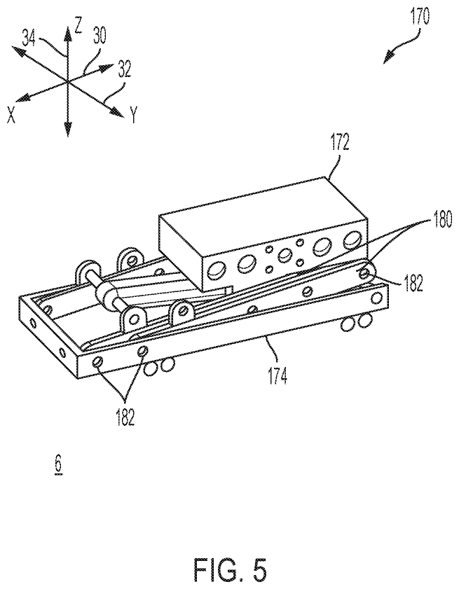

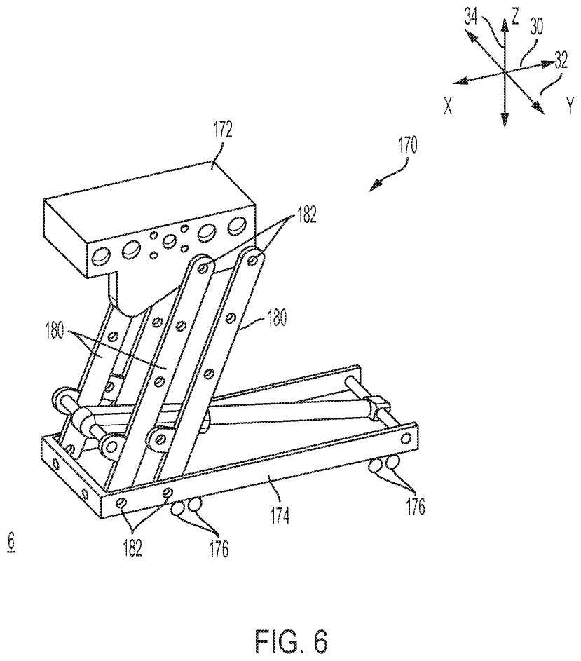

Because the receptacle cavity 16 is located on the underbody 22 of the electric vehicle 4, the receptacle 18 may be spaced in the vertical direction 34 from the ground surface 6. To elevate with respect to the receptacle cavity 16, the extension mechanism 120 can be operatively associated with a lift mechanism or lift jack 170 that can be vertically raised and lowered with respect to the vertical direction 34. Referring to FIGS. 5 and 6, in an example, the lift jack 170 can be a mechanical linkage or assembly including a plurality rigid links that are pivotally joined by revolute joints to move the jack between a lowered state (FIG. 5) and a raised state (FIG. 6). The lift jack 170 can include an upward facing jack platform 172 sized and configured for reception into the receptacle cavity. The jack platform 172 can be adapted to carry the plug to the receptacle cavity and can include features to secure or position the plug. The jack platform 172 can be a planar surface and can be translated upwards and downwards while maintaining a parallel orientation with respect to the ground surface 6. To support the assembly, the lift jack 170 may include a lower base 174 that is generally parallel to and positioned below the jack platform 172 and is configured for interacting with the ground surface. The lower base 174 may be supported on a plurality of wheels 176 or rollers to facilitate movement of the lift jack 170 over the ground surface 6.

In the lowered or collapsed state, illustrated in FIG. 5, the jack platform 172 and the planar base 174 may be adjacent each other such that the lift jack 170 has a low vertical profile to facilitate insertion and movement underneath the electric vehicle. To raise the jack platform 172, as illustrated in FIG. 6, the lift jack 170 can include a plurality of rigid articulating legs 180 that are disposed to either side of the jack and that interconnect the jack platform 172 and the lower base 174. The rigid articulating legs 180 may be connected at their ends to the jack platform 172 and the lower base 174 by revolute joints or pivots 182 such that the jack has the general arrangement of a four-bar linkage. The articulating legs 176 can therefore pivot between lowered positions in which the legs are substantially horizontal and raised positions in which the legs are substantially upright. When the articulating legs 176 are in the pivotally raised position, the jack platform 172 is spaced and suspended above the lower base 174. To actuate the lift jack 170 between lowered and raised states, a rod 184 and a linear slide 186 can be operatively connected between the lower base 174 and the plurality of articulating legs 180 and may be located midwidth between the legs 180 at either side. Further, the slide 186 may be pivotally connected to the articulating legs 180 to establish a mechanical advantage such that when the slide 186 moves with respect to the rod 184, the articulating legs 180 articulate with respect to the pivots 182 to move between the lower and raised positions, resulting in translation of the jack platform 172 in the vertical direction 34. Any suitable motive force may be used to cause the slide 186 to move with respect to the rod 184 including, for example, a mechanical crank.

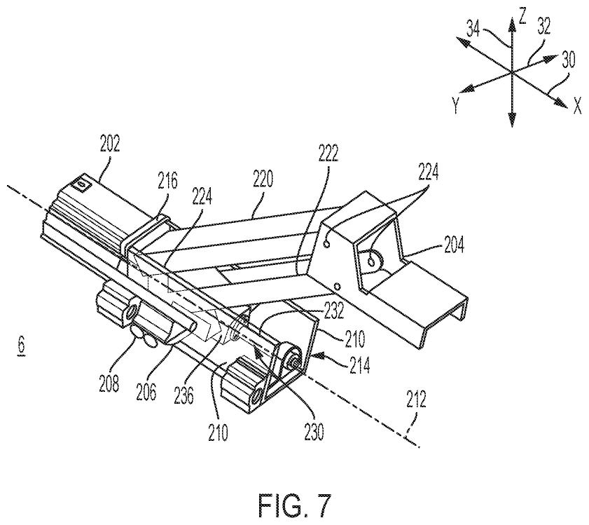

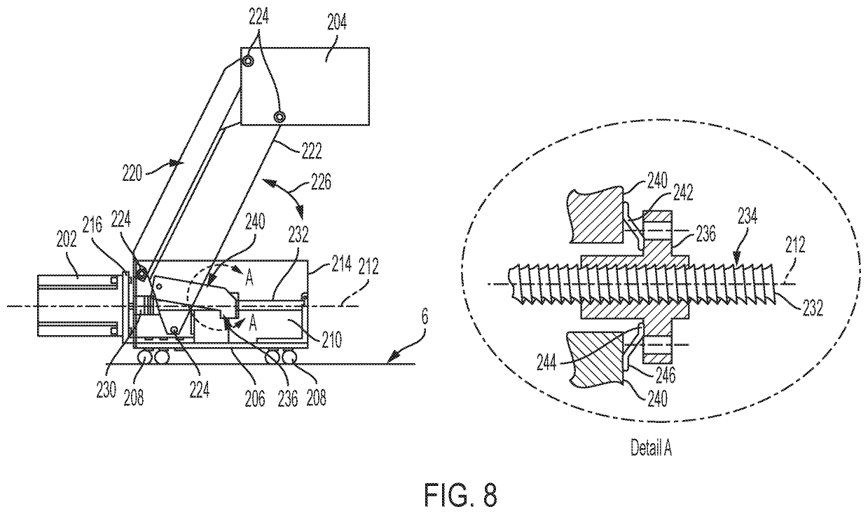

Referring to FIGS. 7 and 8, there is illustrated another example of a lift jack 200 that includes an electric jack motor 202 for electrical actuation to raise and lower an upper jack platform 204 with respect to a lower base 206. The jack platform 204 can include a flat planar surface that is horizontally positioned parallel to the ground and can be sized and configured for reception into the receptacle cavity of the electric vehicle. The jack platform 204 can be adapted to carry the plug to the receptacle cavity and can include features to secure or position the plug The lower base 206 may be supported on wheels 208 and be configured to interact with and traverse over the ground surface. The lower base 206 may be configured as a three-walled frame with three sidewalls 210 positioned and intersecting at right angles in a U-shape about a jack axis 212 that linearly extends over the length the lift jack 200. When coupled to the extension mechanism, the jack axis 212 may align with the linear direction 30. The three walls 210 of the three-walled frame may be further joined at the front and rear by a corresponding front wall 214 and rear wall 216 to form a rectangular, box-shaped structure. To translate the jack platform 204 with respect to the lower base 206, the lift jack 200 can again be a mechanical device generally configured as a four-bar linkage with a plurality of articulating links or legs including a pair of upper articulating legs 220 and a pair of lower articulating legs 222. Resolute joints or pivots 224 pivotally connect the upper and lower articulating legs 220, 222 at one end to two opposing walls 210 of the lower base and at the other end to the jack platform 204. The upper and lower articulating legs 220, 222 can articulate between a position in which they are generally horizontal and the lift jack 200 is collapsed and where they are substantially vertical and the lift jack 200 is in a raised state, as may be indicated by the articulation arrow 226.

To electrically actuate the lift jack 200, the jack motor 202 can be a DC motor mounted to the rear wall 216 of the lower base 204 to align with the jack axis 212. The jack motor 202 can be operatively connected with a linear screw mechanism such as a leadscrew 230 that extends between and is journalled to the front wall 214 and the rear wall 216 of the frame of the lower base 204 and is aligned with the jack axis 212. The leadscrew 230 includes an elongated rod 232 that has helical threads 234 disposed axially about its circumference. The leadscrew 230 can include a screwnut 236 disposed about the threaded rod 232 and that includes mating threads disposed in an inner bore 238. The screwnut 236 can be a block-like structure with surfaces that can abut against corresponding leg blocks 240 that can be formed on the insides of the upper and lower articulating legs 220, 222 that are pivotally connected to the jack platform 204 and the lower base 206. Rotation of the jack motor 202 rotates the leadscrew 230 causing the screwnut 236 to move axially with respect to the jack axis 212. If the rotation moves the screwnut 236 rearward with respect to the jack axis 212 toward the rear wall 216, the screwnut abuts 236 against the leg blocks 240 displacing them rearward as well. Because of the pivotal connection between the upper and lower articulating legs 220, 222 with the lower base 206, the pivots 224 translate the rearward motion of the leg blocks 240 to articulated pivoting of the upper and lower articulating legs 220, 222 to vertically raise the upper jack platform 204. It will be appreciated that the DC configured jack motor 202 can be controlled to accurately determine the vertical elevation of the jack platform 204. In accordance with the disclosure, a ball screw or a worm screw may be used instead of a leadscrew 230.

Referring to Detail A in FIG. 8, to provide compliance to the lift jack 200, for example, to accommodate shock loading, a compliant structure 242 or spring may be disposed between the screwnut 236 and the leg blocks 240 on the legs. Examples of compliant elements include Belleville washers, spring washers, split washers, coil springs, elastic washers, and the like. The compliant structure 242 is disposed so that, for example, one leg 244 adjacently abuts the screwnut 236 and another leg 246 adjacently abuts a surface of the leg block 240. In the present example, the threading of the leadscrew may be adapted to prevent back driving. The compliant structure 242 will allow relative axial movement between the screwnut 236 and the leg block 240 with respect to the jack axis 212. Accordingly, referring to FIG. 8, if a vertical force is imposed downwardly on the jack platform 204, the pivotally connected upper and lower articulating legs 220, 222 will articulate forcing the leg blocks 240 forwardly with respect to the jack axis 212. The compliant structure 242 can be compliantly compressed between the screwnut and the leg blocks 240 until the vertical force dissipates or is removed from the loading platform 204. The compliant structure 242 may urge the leg blocks 240 rearward again to regain any vertical displacement. Disposing the compliant structure 242 at the interface between the pivoting legs 220, 222 and the translating screwnut 236 enables the lift jack 200 to accommodate vertical displacements by translating them to axial movements with respect to the jack axis 212 that compresses and are dissipated by the complaint structure. In other examples, more than one or a plurality of compliant structures may be disposed between the screwnut and the leg blocks.

In another example of providing compliance to the lift jack 200, wherein the jack motor 202 is a DC motor, the jack motor may be configured to generate a counter torque to accommodate or resist vertical loading or shock to the jack platform 206. In particular, a vertically downward directed force applied to the jack platform 206 will articulate the pivotally connected upper and lower articulating legs 220, 222 downwardly with respect to the articulation angle 226 causing axial motion of the leg blocks 240 against the screwnut 236. If the screwnut 236 is forced to move with respect to the jack axis 212, the threaded rod 232 of the leadscrew 230 may be forced to rotate about the jack axis. In the present example, the leadscrew may be adapted for back driving to allow rotation of the threaded rod 232 in response to the axial motion of the screwnut 236. Rotational movement of the threaded rod 232 is transferred to the jack motor 202 by the operative coupling between the leadscrew 230 and motor. The electromagnetic interaction between the windings of the jack motor 202 will resist rotation of the leadscrew 230 providing a counteractive or resistive force back through the linkages of the lift jack 200. It can be appreciated that if the jack motor 202 does rotate to some extent, the electromagnetic interaction between the windings will attempt to counter rotate the motor and threaded rod 232 coupled thereto, which may result in vertical repositioning of the jack platform 204 after the vertical load is removed. Thus, the jack motor 202 may provide additional compliance to the lift jack 200.

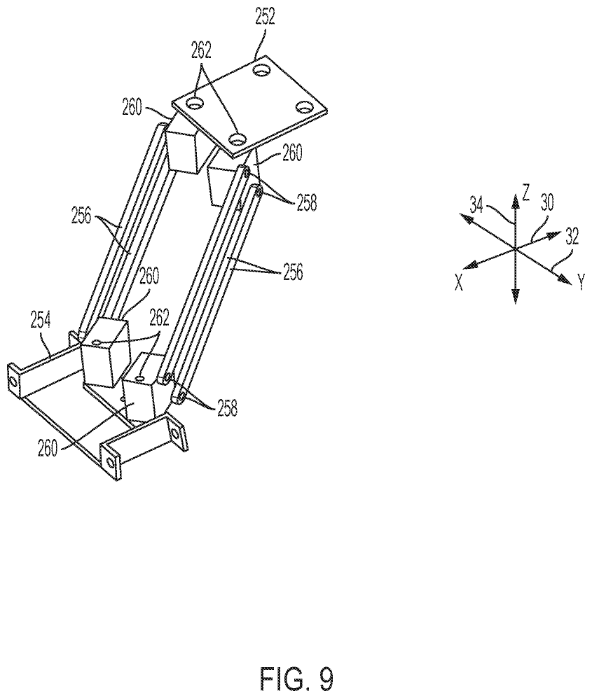

Referring to FIG. 9, there is illustrated another compliance assembly 250 that may be included as part of the lift jack. The compliance assembly 250 can include an upper platform 252 and lower base 254 that can be mounted to the lift jack or elsewhere. To enable the upper platform 252 and the lower base 254 to vertically translate with respect to each other, a plurality of rigid links or leg 256 that may be arranged similar to a four-bar linkage can extend between and connect to the sides of the platform and lower base. To create pivotal connections between the upper platform 252, lower mounting base 254, and the plurality of articulating legs 256, a plurality of rotatable pivot blocks 260 can be disposed on the platform and the lower base respectively. In an example, the rotatable pivot blocks 260 can be rectangular blocks that the articulating legs 256 are pivotally connected at pivot joints 258 to facilitate motion in the vertical direction 34. In addition, the rotational blocks 260 can be connected to the jack platform 252 and/or the lower base 254 by revolute joints or pivots 262 arranged to allow the pivot blocks 260 to rotate with respect to the vertical orientation 34. The pivot blocks 260 therefore allow the jack platform 252 and the lower base 254 to move laterally in addition to vertically with respect to each other, such that the compliant assembly 250 accommodates motion in both the lateral Y-direction 32 and the vertical Z-direction 34.

The lift jack 170 may have other configurations and may operate based on other principles to raise and lower the jack platform. For example, instead of illustrated four-bar linkage, the lift jack 170 may be configured as a scissors linkage or may use rotating threads for extending and retracting a threaded rod. The lift jack 170 may utilize different actuating forces and, for example, may be an electro-magnetic device, may use hydraulic pressure, or may be a pneumatically inflatable bladder. In an example, the jack lift may be configured as a rotatable right-angled bracket that has an axis of rotation parallel to the ground surface and can rotate with respect to the ground surface. As the right angled bracket rotates and pivots against the ground, the bracket will vertically lift the jack platform or distal end of the extension mechanism, such that the platform or distal end “stands” with respect to the ground.

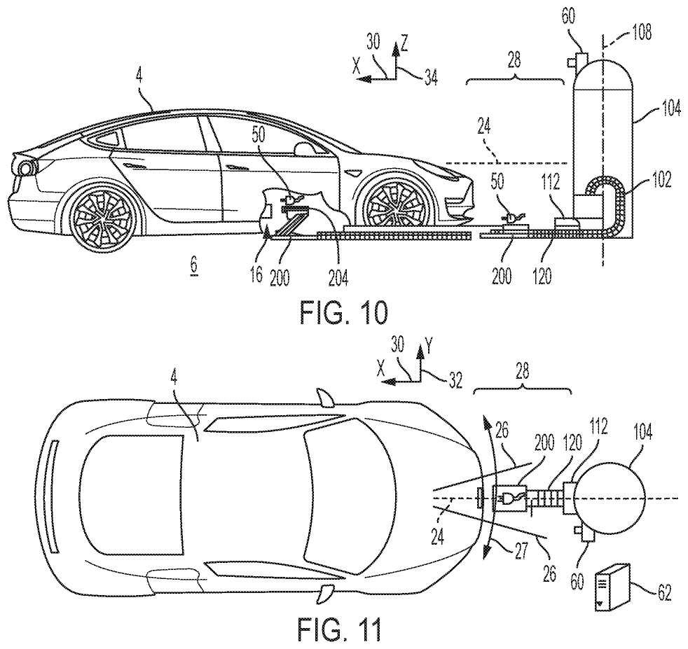

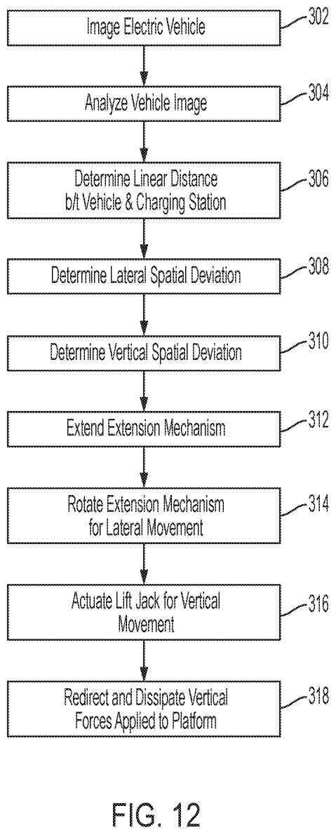

Referring to FIGS. 9 and 10, a process for automatically conductively charging an electric vehicle 4 with the charging station 100 of the disclosure is illustrated. To assist with the process, the charging station 100 may be operably associated with a camera 60 or similar visual recognition technology to recognize and measure any spatial deviation between the electric vehicle 4 and the charging station. In addition to the camera 60, other spatial determination technologies may include LIDAR and satellite positioning. In the example with the camera 60, the camera 60 may be physically positioned on the station housing 104 or may be at a location remote from the station housing 104. The camera 60 may be operatively associated with a computer 62 having processing capabilities to interpret spatial coordinates and distances and to control the alignment mechanism 102 accordingly. For example, the computer 62 may include a microprocessor such as a general purpose processor, an application specific integrated circuit (ASIC), a field programmable gate array (FPGA) or other device having circuitry for reading data and executing instructions written in computer readable software code. The computer 62 may also include storage capabilities such as RAM, ROM, or magnetic storage for storing in a non-transitory manner computer executable software. Depicted in FIG. 12 is an example of a computer executable routine or algorithm the computer 62 may execute for conducting the charging process, which may be written or embodied in computer executable non-transitory software.

As described with respect to FIG. 1, the electric vehicle 4 may approach and stop at a linear distance 28 spaced-away from the charging station 100 to avoid contacting the station housing 104 projecting vertically from the ground surface 6 with respect to the vertical direction 34 or Z-axis. To determine the linear distance 28, and any spatial deviation 26 between the centerline path 24 of the electric vehicle 4 and the charging station 100, the camera 60 in an imaging step 302 may image the vehicle with respect to the station. The computer 62 may process and analyze the images in an analysis step 304 to estimate the spatial coordinates with respect to the electric vehicle. The computer 62, in a first spatial determination step 306, may determine based on the analysis of the image that the electric vehicle 4 is positioned at a given linear distance 28 from the charging station 100 in terms of, for example, feet or meters in the linear direction 30 or X-axis. In addition to resolving the linear distance 28, the computer 62 can also execute second and third spatial determination steps 308 and 310 to determine whether there exists any spatial discrepancy in the lateral direction (Y-axis) or vertical direction (Z-axis) in similar units. The computer 62 may also determine other spatial discrepancies with respect to any of the rotational degrees of freedom.

To traverse the linear distance 28, the computer 62 in an extension step 312 can direct the charging station 100 to extend the extension mechanism 120 so that the distal end 124 protrudes through the axis port 112 of the station housing 104. Disposed at the distal end 124 can be a lift jack, for example, the lift jack 200 depicted in FIGS. 7 and 8. The electric plug 50 may be accommodated on the jack platform 204 of the lift jack 200 at the distal end of the extension mechanism 120. To pass underneath the electric vehicle 4, the lift jack 200 may be in the vertically collapsed state to maintain a low profile with respect to the vertical direction 34. During extension, the extension member 120 is adjacent the ground surface 6 to further enable passing underneath the electric vehicle 4. The configuration of the extension motor may enable accurate linear alignment of the distal end 132 with the receptacle cavity 16 on the electric vehicle 4.

If the computer 62 determines there is any spatial deviation 26 with respect to the centerline path 24 of the electric vehicle 4, the computer in a rotation step 314 can direct the alignment mechanism 102 to rotate with respect to the vertical axis 108 of the station housing 104. It will be appreciated that rotation with respect to the vertical axis 108 causes the linearly extended distal end 124 of the extension mechanism 120 to move in an arc with respect to the lateral direction 32. Movement of the distal end 124 in the lateral direction 32 counters any spatial deviation along the deviation angle 27. The computer 62 may simultaneously command extension or retraction of the extension mechanism 120 to compensate for any movement in the linear direction 30 caused by rotating the extension mechanism.

When the distal end 124 of the extension mechanism 120 is linearly and laterally aligned with the receptacle cavity 16 on the underbody 22 of the electric vehicle 4, the computer 62 may cease any further extension of the extension mechanism 120 or rotation of the alignment mechanism 102. To position the plug 50 within the receptacle cavity 16, the computer 62 may in a vertical actuation step 316 actuate the lift jack to vertically raise the jack platform 204 with respect to the vertical direction 34 or Z-axis. Once received in the receptacle cavity 16, additional features of the electrical vehicle 4 within the cavity can further manipulate the plug 50 to complete the conductive connection. To remove the plug 50, the foregoing process can be reversed and the alignment mechanism 102 can retract the extension mechanism 120 so that it does not interfere with the electric vehicle 4 while it is driving away from the charging station 100.

The example of the lift jack 200 that includes a compliant structure 242 (FIG. 8) may accommodate vertically directed forces imparted to the electric vehicle 4 during charging. For example, if passengers or payload enter or exit the electric vehicle 4, the suspension may compress or rebound, thereby moving the vehicle underbody 22 in the vertical direction 34 or Z-axis with respect to the ground surface 6. This movement may disconnect the plug and receptacle or break the pins and/or prongs of the plug and receptacle. Because the lift jack 200 is configured to translate movement of the underbody in the vertical direction 34 to axial motion in the linear direction 30 and provides a compliant structure 42 in that direction, disconnection or damage may be avoided. Accordingly, as indicated by step 318, while the electric vehicle is charging, the lift jack component of the alignment mechanism may be capable of redirecting and dissipating forces vertically applied to the jack platform.

The example of a compliance assembly 250 that may be included with the lift jack 200 also accommodates loading and/or unloading of the electric vehicle 4 while charging. For example, if a driver or passenger enters on one side of the electric vehicle 4, the vehicle may tend to roll with respect to the centerline path 24 so the underbody 22 moves vertically toward the ground surface 6 at the one side. Rolling movement in the vertical direction 34 also may translate to movement in the lateral direction 32 or Y-axis. The compliance assembly 250 with pivot blocks 260 configured to rotate with respect to the vertical direction 34 can accommodate this imparted lateral motion and may avoid transferring lateral strain to the linearly extended extension mechanism 120.

Hence, in accordance with an aspect of the disclosure, the charging station 100 has multiple translational degrees of freedom to conductively interact with an electrical vehicle 4 disposed in a linearly spaced relation to the charging station. These motions include linearly extending and retracting an extension mechanism linearly towards and away from the vehicle 4 in a linear direction 30. The alignment mechanism 102 can also laterally move a distal end 124 of the extension mechanism 120 in a lateral direction 32 with respect to the vehicle. In addition, the alignment mechanism 102 can also vertically raise and lower a lift jack 200 at the distal end with respect to the vertical direction 34. Because the multiple degrees of freedom facilitate the spaced-apart relation between the electric vehicle 4 and the charging station 100, the charging station or at least parts thereof do not need to be located underneath the vehicle and do not need to be constructed to avoid interference with, or support the weight of, the vehicle.

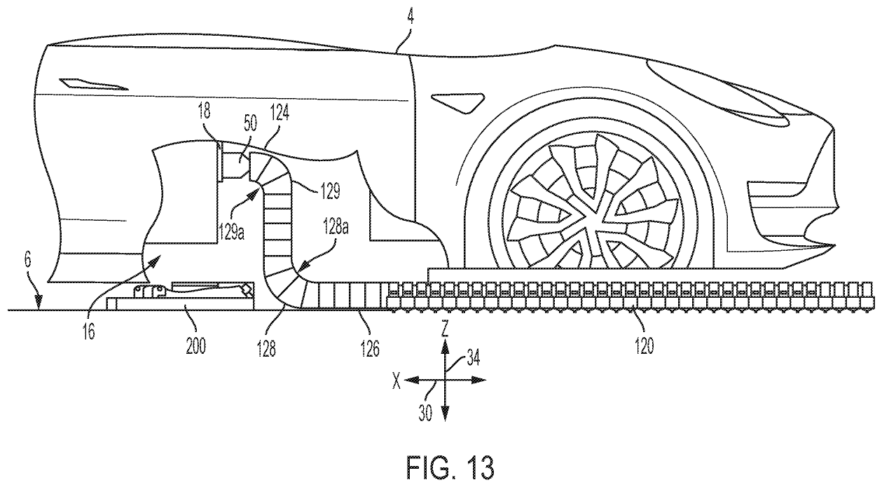

Referring to FIG. 13, there is illustrated an example of possible electrical connection between the receptacle 18 in the receptacle cavity 16 and plug 50. The illustrated connection may be feasible when the extension mechanism 120 accommodates an electrical conductor, for example, as disposed inside the plurality of hollow, adjacent links 130 that forms the complaint track 126. In such an example, the plug 50 may be attached to the distal end 124 of the extension mechanism 120 and electrically connected to the conductor disposed therein. As depicted, the plug 50 and the distal end 124 of the connector mechanism 120 may have been vertically moved into the receptacle cavity 16 by the lift jack 200, which has since been lowered with respect to the vertical dimension 34 to the collapsed state adjacent the ground surface 6. However, because of the mating connection between the receptacle 18 and the plug 50, the plug is retained at a vertically elevated height with respect to the ground surface 6. In the illustrated example, the receptacle 18 and plug 50 mate in the linear direction 38, but in other examples, the mating connection can occur at different orientations.

Because the distal end 124 of the extension mechanism 120 remains attached to the plug 50, it will be appreciated that a portion of the extension mechanism must extend vertically into the receptacle cavity 16. The complaint characteristic of the compliant track 126 can assume a configuration to support the connection. As illustrated in FIG. 13, because of the pivotally connected links 130, the complaint track 126 can assume one or more curves including a lower curve 128 and an upper curve 129. The lower curve 128 redirects the compliant track 126 from adjacent the ground surface 6 vertically upwards toward the receptacle cavity 16. The lower curve 128 thus re-orientates the compliant track 126 from the linear direction 30 or X-axis to the vertical direction 34 or Z-axis. The upper curve 129 redirects the complaint track 126 from the vertical direction 34 to the linear direction 30 toward the receptacle 18. The curved arrangement of the compliant track 126 compliantly reinforces the electrical connection of the receptacle 18 and plug 50. In particular, because the compliant track 126 has sections extending in both the linear direction 30 and the vertical direction 34, it may be relatively rigid and supported in those directions.

However, if any forces are impart by the electric vehicle 4, for example, due to passengers entering and exiting, the upper and lower curve 128, 129 allow for some degree of bending or rolling to accommodate forces in the linear or vertical directions 30, 34 for example, by allowing the curves to undulate or roll. For example, the upper and lower curves 128, 129 can each have an associated radius of curvature 128a, 129a as illustrated. If the electric vehicle 4 is displaced in the vertical direction 34 or Z-axis with respect to the ground, the radius of curvature 128a, 129a may decrease (tighter bending), increase (wider bending), or undulate (roll) to accommodate the displacement. Likewise, if the electric vehicle 4 is displaced in the linear direction 30 or X-axis, the radius of curvature 128a, 129a can respond accordingly. Thus, the compliance or flexibility associated with the compliant track 126 enables the extension mechanism 120 to accommodate displacement of the electric vehicle 4 while charging.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An automatic conductive charging station for charging an electrical vehicle comprising:
a station housing extending in vertical direction to define a vertical axis;
an alignment mechanism accommodated in the station housing, the alignment mechanism including:
an extension mechanism extendable and retractable with respect to the station housing in a linear direction that is normal to the vertical axis; and
a lift jack disposed at a distal end of the extension mechanism and actuatable to vertically raise and lower a jack platform with respect to the vertical axis.

2. The charging station of claim 1, further comprising a rotatable platform configured to angularly rotate the extension mechanism with respect to the vertical axis.

3. The charging station of claim 2, wherein the extension mechanism includes a proximal end opposite the distal end and fixedly attached to the station housing.

4. The charging station of claim 3, wherein the station housing includes an access port disposed near a housing floor of the station housing to provide access for the distal end of the extension mechanism during extension and retraction.

5. The charging station of claim 4, wherein the extension mechanism includes a compliant track extending between the proximal end and the distal end.

6. The charging station of claim 5, wherein the compliant track includes plurality of pivotally connected links.

7. The charging station of claim 6, the compliant track extends vertically upwards from the proximal end and extends vertically downwards to the distal end when retracted in the station housing.

8. The charging station of claim 7, wherein the plurality of pivotally connected links of the compliant track can accommodate a undulating curve over the length of the compliant track during extension and retraction of the extension mechanism.

9. The charging station of claim 8, wherein the alignment mechanism includes an extension-retraction drive to extend and retract the extension mechanism.

10. The charging station of claim 9, wherein the extension-retraction drive includes a sprocket to mesh with a cog on each of the plurality of pivotally connected links.

11. The charging station of claim 1, wherein the lift jack includes a mechanical linkage adapted to raise and lower the jack platform with respect to a lower base.

12. The charging station of claim 11, wherein the mechanical linkage includes a plurality of articulating legs pivotally connected to the jack platform and the lower base, the articulating legs articulable to translate the jack platform between a raised state and a collapsed state.

13. The charging station of claim 11, wherein the lift jack includes a jack motor comprising a jack motor to actuate the lift jack.

14. The charging station of claim 12, wherein the jack motor and the mechanical linkage are operably connected by a linear screw mechanism having a screwnut axially movable with respect to a threaded rod, the screwnut abutting a leg block disposed on at least one of the plurality of articulating legs

15. The charging station of claim 13, wherein the lift jack further comprises a compliant structure disposed between the screwnut and the leg block to absorb vertical forces applied to the jack platform.

16. The charging station of claim 14, wherein the compliant structure is selected from the group comprising a Belleville washer, a spring washer, a split washer, a coil spring, and an elastic washer.

17. A computer-implement method of automatically conductively charging an electric vehicle comprising:
determining by the computer a linear distance and lateral spatial deviation between a charging station and an electric vehicle having an underbody receptacle cavity;
extending in a linear direction the distal end of an extension mechanism from the charging station base to a position underneath the electric vehicle; and
actuating a lift jack at the distal end of the extension mechanism to raise a jack platform into the receptacle cavity.

18. The method of claim 17, further comprising determining by the computer a lateral spatial deviation between the charging station and an electric vehicle.

19. The method of claim 18, further comprising rotating at least part of the charging station to laterally move the distal end of the extension mechanism with respect to the underbody receptacle cavity.

20. The method of claim 19, wherein the extension mechanism further includes:
a proximate end opposite the distal end and fixedly attached to the charging station base; and
a compliant track extending between the proximate end and the distal end.

21. The method of claim 20, further comprising meshing a rotatably sprocket in the charging station with a plurality of cogs on the compliant track to extend the extension mechanism.

22. The method of claim 16, further comprising rotating a linear screw mechanism of the lift jack to raise the jack platform.

23. The method of claim 19, further comprising dissipating vertical forces applied to the jack platform with a compliant structure of the lift jack.

24. An automatic conductive charging station for charging an electrical vehicle comprising:
a vertical station housing occupying spatial coordinates at a linear distance from a vehicle space intended for the electric vehicle;
an alignment mechanism having three translational degrees of freedom of motion, the alignment mechanism accommodated in the station housing and configured to:
linearly extend and retract an extension mechanism in a linear direction with respect to the vehicle space; and
vertically elevate a lift jack at the distal end in a vertical direction with respect to the vehicle space.

25. The charging station of claim 24, wherein the alignment mechanism is further configured to laterally move a distal end of the extension mechanism in a lateral direction with respect to the vehicle space.
